(19) United States
(12) Patent Application Publication
(10) Pub. No.: US 2015/0160913 A1
(43) Pub. Date: Jun. 11, 2015

(54) APPARATUS AND METHOD FOR SCREEN SHARING

(71) Applicant: SK PLANET CO., LTD., Seongnam-si (KR)

(72) Inventor: Sangyool LEE, Seongnam-si (KR)

(21) Appl. No.: 14/561,143

(22) Filed: Dec. 4, 2014

(30) Foreign Application Priority Data
Dec. 10, 2013 (KR) 10-2013-0153020

(51) Int. Cl. G06F 3/14

(52) U.S. Cl. CPC G06F 3/1454

(57) ABSTRACT

Provided are an apparatus and method for a screen sharing service, and a screen sharing system for the same. When a display device is connected to a plurality of terminal devices via short-range wireless communication and receives screen sharing information about currently executed content from the plurality of connected terminal devices, a current screen is split by the same number as the number of the terminal devices having transmitted the received screen sharing information, and the received screen sharing information is output to a corresponding split screen, and therefore a screen or a function executed in each of the plurality of terminal devices may be simultaneously output as is to a single display device to be executed, thereby receiving various services from the single display device.

### CROSS-REFERENCE TO RELATED APPLICATION

This application claims priority to and the benefit of Korean Patent Application No. 10-2013-0153020 filed in the Korean Intellectual Property Office on Dec. 10, 2013 the entire contents of which are incorporated herein by reference.

### TECHNICAL FIELD

The present invention relates to an apparatus and method for a screen sharing service, and more particularly, to an apparatus and method for a screen sharing service, which may share a corresponding screen by splitting a screen of a display device connected to a plurality of terminal devices and outputting an execution screen executed in each of the terminal devices connected to the split screen, and a screen sharing system for the same.

### BACKGROUND

The contents described in this part only provide background information about the present embodiment, but do not constitute the prior art.

According to the development of communication technologies, various services have been recently provided using a terminal device. In particular, various services have been provided through linkage among a communication terminal that can receive and execute various content such as a smart phone and other devices.

Among technologies in which a terminal is linked with other devices to listen to music or make a call and control functions of the other devices, screen sharing, that is, technology called mirroring has recently attracted attention. In such mirroring technology, a terminal device is linked with other display devices so that a screen or a function executed in the terminal device can be used as is through a screen of the corresponding display device.

However, in existing minoring technology, a single terminal device for providing content through wired or wireless connection and a single display device are connected with each other to only perform a one-to-one screen sharing service, but mirroring (screen sharing service) through linkage among a plurality of terminal devices and a single display device is not provided.

### SUMMARY

The present invention is directed to providing an apparatus and method for a screen sharing service in which, when a display device is connected to a plurality of terminal devices via short-range wireless communication to receive screen sharing information about currently executed content from the plurality of connected terminal devices, a current screen is split by the same number as the number of the terminal devices having transmitted the received screen sharing information, and the received screen sharing information is output to the corresponding split screen.

One aspect of the present invention provides a display device including: a communication unit that performs communication for screen sharing with a plurality of terminal devices; a screen sharing processing unit that is functionally connected to the communication unit, receives screen sharing information about content currently executed in the terminal device, splits a current screen by the same number as the number of the terminal devices having transmitted the screen sharing information, and controls the received screen sharing information to be output to a corresponding split screen; and an output unit that outputs the received screen sharing information to the corresponding split screen in accordance with control of the screen sharing processing unit.

Here, when receiving the screen sharing information about the currently executed content from a single specific terminal device, the screen sharing processing unit may control the received screen sharing information to be output to the entire screen.

Also, when screen sharing information about another content is currently output to a screen of the output unit, the screen sharing processing unit may split the current screen, map identification information of the terminal device having transmitted the screen sharing information on one of split screens, and control the received screen sharing information to be output to the mapped split screen.

Also, the screen sharing processing unit may split the screen in accordance with a condition that is determined in advance by a user in consideration of at least one of a screen size of the output unit, a screen resolution, and a type of the content.

Also, the screen sharing processing unit may merge adjacent split screen regions when there is an empty split screen from which the screen sharing information is not output among at least two split screens, and split the merged screen region again when receiving new screen sharing information.

Also, the screen sharing processing unit may control the received screen sharing information in accordance with a priority set in advance by a user in consideration of sizes of at least two split screens in the order of the sizes of the split screens.

Also, the screen sharing processing unit may split a screen of the output unit by the same number as the number of the terminal devices currently connected via short-range wireless communication, and output content information directly executed in the display device to an empty split screen from which the screen sharing information is not output among at least two split screens.

Also, when content which is received directly from the display device to be executed occurs, the screen sharing processing unit may set the number of split screens by adding the content, and split a screen currently executed by the set number of split screens.

Also, when a control signal is generated, the screen sharing processing unit may receive content information in accordance with the control signal directly from a service device for providing the content, output the received content information to a corresponding split screen in which the control signal is generated, transmit the received content information to the terminal device mapped on the corresponding split screen, and control the content information to be output in the same manner as in the corresponding split screen.

Also, when a control signal is generated, the screen sharing processing unit may verify identification information mapped on a split screen in which the control signal is generated, transmit the control signal to the terminal device corresponding to the verified identification information, receive screen sharing information about the output content in accordance with the control signal from the terminal device corresponding to the identification information, and control the received screen sharing information to be output to the split screen in which the control signal is generated.

Also, the screen sharing information may include at least one of a mirrored screen in the terminal device, a content voice, and content data.

Another aspect of the present invention provides a terminal device including: a communication unit that performs communication for screen sharing via a communication network with a display device connected via the communication network; a control unit that generates screen sharing information about content executed on a current execution screen in accordance with a screen sharing request of a user, and controls a screen sharing request message including the generated screen sharing information to be transmitted to the display device so that the same screen as the current execution screen is output to a split screen region of the display device allocated to the terminal device itself; and an output unit that outputs an execution screen about the content.

Here, the control unit may be connected to the display device acting as an access point via short-range wireless communication.

Also, when receiving a control signal from the display device, the control unit may output content information provided in accordance with the received control signal to the execution screen, generate screen sharing information about content currently output to the execution screen, and transmit the generated screen sharing information to the display device so that the generated screen sharing information is equally output to a corresponding split screen of the display device.

Also, when a control signal in accordance with a request of the user is generated, the control unit may output content information in accordance with the generated control signal to the current execution screen, generate screen sharing information about content currently output to the execution screen, and transmit the generated screen sharing information to the display device so that the generated screen sharing information is equally output to a corresponding split screen of the display device.

Yet another aspect of the present invention provides a screen sharing service method in a display device including: receiving a screen sharing request message including screen sharing information about content currently executed in at least two terminal devices; splitting a current screen by the same number as the number of at least one terminal device having transmitted the screen sharing information; and outputting the received screen sharing information to a split screen corresponding to the terminal device having requested screen sharing.

Here, the screen sharing service method may further include: performing a connection procedure with the at least two terminal devices in accordance with a connection request of the at least two terminal devices through an access point function of short-range wireless communication.

According to the present invention, screen sharing information about currently executed content is received from a plurality of terminal devices to which a display device is connected, and the received screen sharing information is output to a corresponding split screen region so that a screen or a function executed in each of the plurality of terminal devices is simultaneously output and executed as is in a single display device, whereby various services may be provided from the single display device.

### BRIEF DESCRIPTION OF DRAWINGS

FIG. 1 is a view showing a configuration of a screen sharing service system according to an embodiment of the present invention;

FIG. 2 is a view showing a configuration of a terminal device for a screen sharing service in a screen sharing service system according to an embodiment of the present invention;

FIG. 3 is a view showing a configuration of a display device for a screen sharing service in a screen sharing service system according to an embodiment of the present invention;

FIG. 4 is a view showing an example in which a display device shares screens of a plurality of terminal devices according to an embodiment of the present invention;

FIG. 5 is a view showing a method for a screen sharing service in a terminal device according to an embodiment of the present invention; and

FIG. 6 is a view showing a method for a screen sharing service in a display device according to an embodiment of the present invention.

### DETAILED DESCRIPTION

Hereinafter, preferred embodiments of the present disclosure will be described in detail with reference to the accompanying drawings. When it is determined that the detailed description of known art related to the present invention may obscure the gist of the present invention, the detailed description thereof will be omitted. The same reference numerals are used to refer to the same element throughout the specification.

Prior to the description, it should be understood that the terms used in the specification and the appended claims should not be construed as limited to general dictionary meanings, but interpreted based on the meanings and concepts corresponding to technical aspects of the present disclosure on the basis of the principle that the inventor is allowed to define terms appropriately for the best explanation. Therefore, the description proposed herein is merely a preferable example for the purpose of illustration only, not intended to limit the scope of the disclosure, and thus it should be understood that other equivalents and modifications could be made thereto without departing from the spirit and scope of the disclosure.

Hereinafter, a screen sharing service system according to embodiments of the present invention will be described in detail with reference to the accompanying drawings.

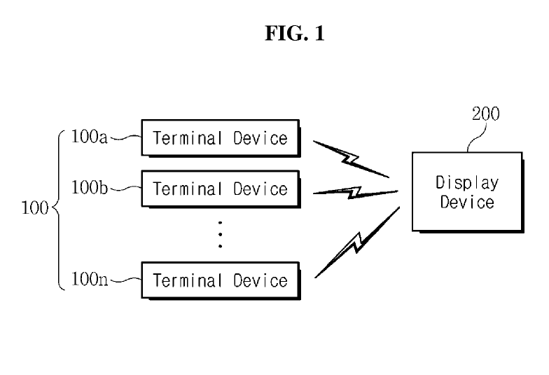

FIG. 1 is a view showing a configuration of a screen sharing service system according to embodiments of the present invention.

Referring to FIG. 1, the screen sharing service system may include a plurality of terminal devices 100 (100a, 100b, and 100c), and a display device 200.

The terminal device 100 may refer to a terminal that can transmit and receive a variety of data via a communication network 10 in accordance with key operations of a user, and be any one of a tablet PC, a laptop, a personal computer (PC), a smart phone, a personal digital assistant (PDA), a smart TV, a mobile communication terminal, and a navigation device.

In addition, the terminal device 100 may be a terminal that performs voice or data communication, and refer to a terminal including a browser for communicating with a service device (not shown) via a communication network, a memory for storing programs and protocols, a microprocessor for executing various programs to operate and control the various programs. That is, the terminal device 100 is not limited as long as it can perform server-client communication with the service device, act as a content source device that stores and executes content provided from the service device, and execute screen sharing services, and has a wide concept including all of communication computing devices such as a notebook computer, a mobile communication terminal, PDA, navigation device, and the like. Meanwhile, the terminal device 100 is preferably manufactured in the form including a touch screen, but is not necessarily limited thereto.

In particular, the terminal device 100 according to the embodiments of the present invention may perform communication for screen sharing with the display device 200 connected via short-range wireless communication, generate screen sharing information about content executed in a current execution screen in accordance with a screen sharing request of a user, and control a screen sharing request message including the generated screen sharing information to be transmitted to the display device 200 so that the same screen as the current execution screen is output to a split screen region of the display device allocated to the terminal device 100 itself.

The display device 200 may have an access point function for performing 1 to n connection, be linked with at least two terminal devices 100 via short-range wireless communication, and receive and output the screen sharing information about the content currently executed in the at least two terminal devices 100. For this, the display device 200 may split a current screen by the same number as the number of the terminal devices 100 having transmitted the screen sharing information, and output the received screen sharing information to a corresponding split screen. As the display device 200, a projector, a TV (or IPTV), a monitor, a terminal device acting as an access point among terminal devices for performing screen split, and the like may be used.

The terminal device 100 is linked with the display device 200 acting as an access point via short-range wireless communication (Wi-Fi), the terminal device 100 is linked with a service device (not shown) provided with content via a communication network, and the communication network refers to a network that can transmit and receive data with Internet protocol using a variety of wired/wireless communication technologies such as an Internet network, intranet network, mobile communication network, satellite communication network, and the like. In addition, the communication network is coupled to the service device to store computing resources such as hardware, software, and the like. Such a communication network is the collective concept for a network such as Code Division Multiple Access (CDMA), Wideband Code Division Multiple Access (WCDMA), Global System for Mobile Communication (GSM), Long Term Evolution (LTE), Evolved Packet Core (EPC), or the like, and a next-generation network to be implemented in the future and a computing network as well as a closed network such as Local Area Network (LAN), Wide Area Network (WAN), or the like and an open network such as Internet.

In the screen sharing service system configured as the above, a configuration of the terminal device according to an embodiment of the present invention will be described with reference to the accompanying drawings.

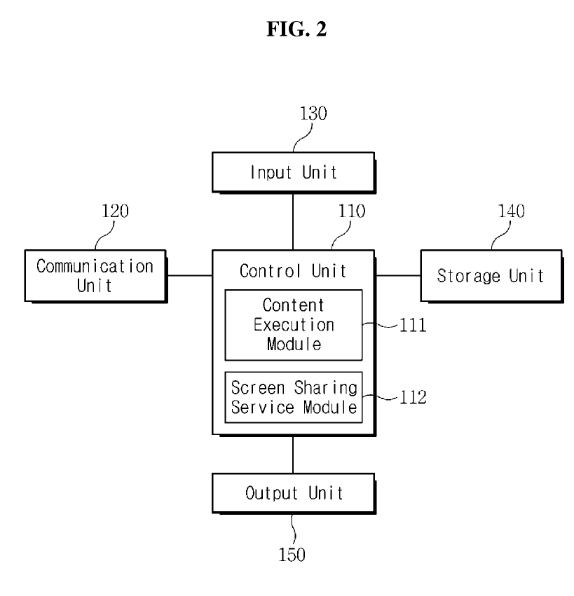

FIG. 2 is a view showing a configuration of a terminal device for a screen sharing service in a screen sharing service system according to an embodiment of the present invention.

Referring to FIG. 2, the terminal device 100 may include a control unit 110, a communication unit 120, an input unit 130, a storage unit 140, and an output unit 150.

The control unit 110 may perform overall control of the terminal device 100, execute content provided particularly from the service device, and control the related operations for sharing a content execution screen. For this, the control unit 110 may include a content execution module 111 and a screen sharing service module 112.

The content execution module 111 may receive content data from a service device linked via a communication network to store the received content data, and execute the provided content in accordance with a user's request to control the executed content to be output to an execution screen of the output unit 150.

The screen sharing service module 112 may generate screen sharing information about content executed on a current execution screen in accordance with a screen sharing request of the user, and generate a screen sharing request message including the generated screen sharing information so that the same screen as the current execution screen is output to a split screen region of the display device 200 allocated to the terminal device 100 itself. Next, the screen sharing service module 112 may be connected to the display device 200 acting as the access point via short-range wireless communication, and transmit the screen sharing request message to the connected display device 200.

In addition, when receiving a control signal from the display device 200, the screen sharing service module 112 may transmit the received control signal to the content execution module 111. Thus, the content execution module 111 may output the provided content information to the execution screen in accordance with the control signal. Next, the screen sharing service module 112 may generate screen sharing information about the content currently output to the execution screen, and transmit the generated screen sharing information to the display device 200 so that the generated screen sharing information is equally output to a corresponding split screen of the display device 200.

In addition, when a control signal according to a user's request is generated, the screen sharing service module 112 may output content information according to the generated control signal to the current execution screen, generate screen sharing information about the content currently output to the execution screen, and transmit the generated screen sharing information to the display device 200 so that the generated screen sharing information is equally output to the corresponding split screen of the display device 200.

The communication unit 120 may transmit and receive content data by performing communication with a service device (not shown) via the communication network 10, and transmit and receive a message for a screen sharing service by communicating with the display device 200 via short-range wireless communication. Such a communication unit 120 may transmit and receive data through various communication methods as well as a wired method and a wireless method. In addition, the communication unit 120 may transmit and receive data using at least one communication method, and for this, the communication unit 120 may include a plurality of communication modules which transmit and receive data in accordance with mutually different communication methods. In particular, the communication unit 120 may transmit to the display device 200 a screen sharing request message including the screen sharing information about the execution screen for the content output to the current execution screen, and receive a control signal for the screen shared in the display device 200 to transmit the received control signal to the control unit 110.

The input unit 130 may generate a user input signal corresponding to a user's request or information in accordance with the user's operation, and be implemented by various input means which are currently available or will be available in the future, and include a gesture input means for generating a specific input signal by detecting the user's motion, as well as general input devices such as a keyboard, a mouse, a joystick, a touch screen, a touch pad, and the like. The input unit 130 may generate an input signal for screen sharing concerning the content output to the current execution screen and an input signal for screen control.

The storage unit 140 may store information required for operations of the terminal device 100, store particularly information and programs (or applications) related to content provided from the service device, and the like, and store screen sharing information generated in accordance with a screen sharing request. Such a storage unit 140 includes magnetic media such as hard disks, floppy disks, or magnetic tapes, optical recording media such as Compact Disk Read Only Memory (CD-ROM) or Digital Video Disk (DVD), magneto-optical media such as floptical disks, ROM, Random Access Memory (RAM), a flash memory, and the like.

The output unit 150 is a means provided so as to enable a user to recognize operational results and statuses of the terminal device 100, and may include a display unit for visually outputting data via a screen, a speaker for outputting audible sound, and the like. In particular, in the present invention, the output unit 150 may display a screen related to content execution driven by the terminal device 100 or a screen related to screen sharing service.

Next, in the screen sharing service system, a configuration of the display device for a screen sharing service according to an embodiment of the present invention will be described in detail with reference to the accompanying drawings.

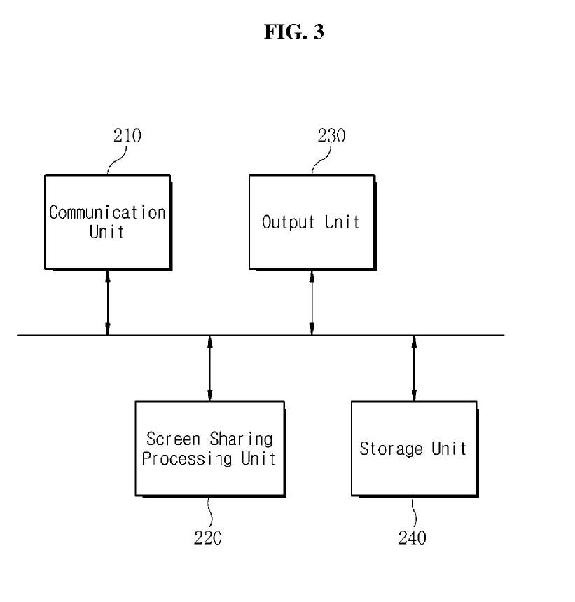

FIG. 3 is a view showing a configuration of a display device for a screen sharing service in a screen sharing service system according to an embodiment of the present invention.

Referring to FIG. 3, the display device 200 may include a communication unit 210, a screen sharing processing unit 220, an output unit 230, and a storage unit 240.

The communication unit 210 may be connected to at least one terminal device 100 via short-range wireless communication to transmit and receive messages for sharing a screen currently executed in the terminal device 100, and act as an access point (AP).

The screen sharing processing unit 220 may be functionally connected to the communication unit 210 to receive a screen sharing request message including screen sharing information about content currently executed in the connected terminal device 100. The screen sharing processing unit 220 may split a current screen by the same number as the number of at least one terminal device 100 having transmitted the screen sharing information included in the received screen sharing request message, and control the received screen sharing information to be output to a corresponding split screen of the output unit 230. Here, the screen sharing information may include at least one of a screen mirrored in the connected at least one terminal device 100, a content voice, and content data.

In addition, the screen sharing processing unit 220 may split the screen of the output unit 230 by the same number as the number of the terminal devices currently connected via short-range wireless communication, or split the screen in accordance with a condition set in advance by a user in consideration of at least one of a screen size of the output unit 230, a screen resolution thereof, and a type of the content.

In a case in which there is no other currently connected terminal device 100 and there is no content that is output to the screen of the output unit 230, the screen sharing processing unit 220 may control, when receiving screen sharing information about the currently executed content from a specific terminal device 100, the received screen sharing information to be output to the entire screen of the output unit 230.

When screen sharing information about other content is currently output to the screen of the output unit 230, the screen sharing processing unit 220 may split a current screen, transmit the screen sharing information to one of the split screens, map identification information of the connected terminal device 100, and control the received screen sharing information to be output to the mapped split screen. In addition, the screen sharing processing unit 220 may merge adjacent split screen regions when there is an empty split screen from which the screen sharing information is not output among at least two split screens, and split the merged screen again when receiving new screen sharing information.

Next, the screen sharing processing unit 220 may control the received screen sharing information in accordance with a priority set in advance by a user in consideration of sizes of at least two split screens in the order of the sizes of the split screens.

In addition, the screen sharing processing unit 220 may output content information directly executed in the empty split screen from which the screen sharing information is not output among at least two split screens, set, when content directly received and executed is generated, the number of the split screens by adding the generated content, and split a current execution screen by the same number as the set number of split screens.

Meanwhile, in a case in which a control signal is generated in the screen of the output unit 230, the screen sharing processing unit 220 may verify identification information mapped on a region in which the control signal is generated when the current screen is the split screen, and transmit the control signal to the terminal device 100 corresponding to the verified identification information. Next, the screen sharing processing unit 220 may receive, from the terminal device 100 corresponding to the identification information, screen sharing information about content that is changed and output in accordance with the control signal, and control the received screen sharing information to be output to a split screen region in which the control signal is generated. Thus, the output unit 230 may output the same screen as the execution screen output in accordance with the control signal from the terminal device 100.

In addition, when a control signal is generated in the screen of the output unit 230, the screen sharing processing unit 220 may receive content information according to the control signal directly from a service device for providing content, output the received content information to a corresponding split screen in which the control signal is generated, and control the received content information to be transmitted to the terminal device 100 mapped on a corresponding split screen so that the transmitted content information is output in the same manner as in the corresponding split screen.

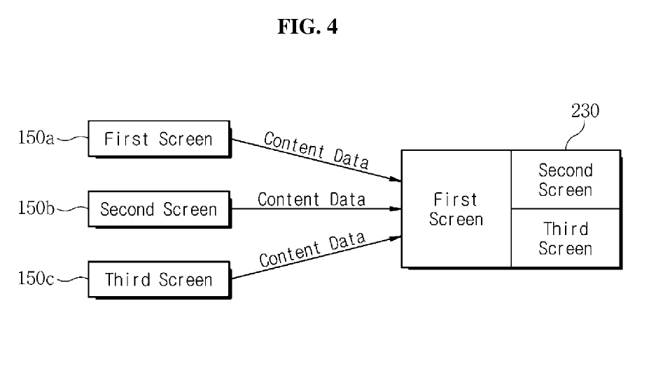

The output unit 230 is a means provided so as to enable a user to recognize operational results or statuses of the display device 200, and may include a display unit for visually outputting data via a screen, a speaker for outputting audible sound, and the like. In particular, in the present invention, the output unit 230 may output the same execution screen (screen sharing information) as a current execution screen related to content execution executed in the terminal device 100 according to control of the screen sharing processing unit 220, that is, a mirrored screen, to the mapped corresponding region (split screen region). For example, as shown in FIG. 4, the output unit 230 may output a first screen currently output in an output unit 150a of the first terminal device 100a to a mapped corresponding split region (first screen region), output a second screen currently output in an output unit 150b of the second terminal device 100b to a mapped corresponding split region (second screen region), and output a third screen currently output in an output unit 150c of the third terminal device 100c to a mapped corresponding split region (third screen region).

The storage unit 240 may store related information for a screen sharing service. Specifically, the storage unit 240 may store screen sharing information received from the terminal device 100, identification information about the connected terminal device 100, and the like, and store content directly received from the service device, execution programs (applications), and the like. The storage unit 240 may include magnetic media such as hard disks, floppy disks, or magnetic tapes, optical recording media such as CD-ROM or DVD, magneto-optical media such as floptical disks, ROM, RAM, a flash memory, and the like.

Hereinafter, a screen sharing service method in the screen sharing service system configured as the above will be described. First, a method for a screen sharing service in a terminal device according to an embodiment of the present invention will be described in detail with reference to the accompanying drawings.

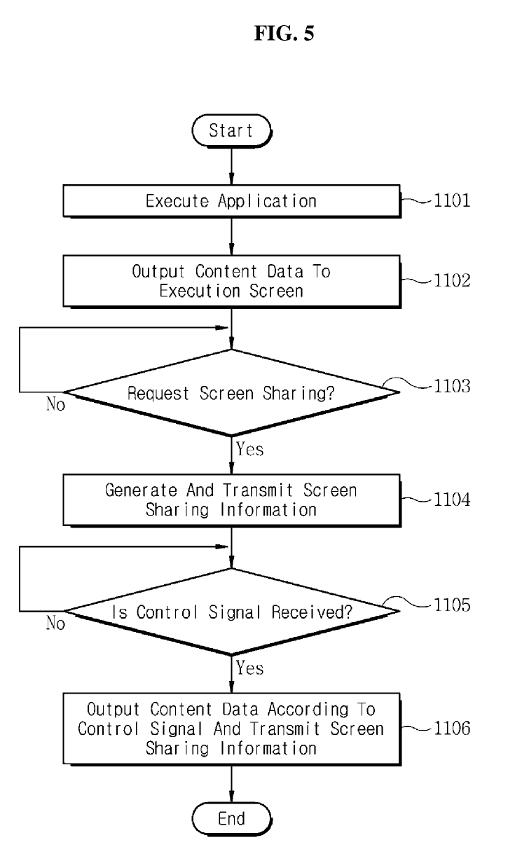

FIG. 5 is a view showing a method for a screen sharing service in a terminal device according to an embodiment of the present invention.

Referring to FIG. 5, in operation 1101, the terminal device 100 executes an application (or program) for content according to a user's request, and outputs content data to an execution screen of the terminal device 100.

Next, in operation 1103, the terminal device 100 verifies whether there is a screen sharing request for currently executed content from a user. In operation 1104, when there is the screen sharing request, the terminal device 100 generates screen sharing information about the currently executed content, and transmits a screen sharing request message including the generated screen sharing information to the display device 200. Thus, the display device 200 outputs screen sharing information to a split screen region mapped on the terminal device 100 having transmitted the screen sharing information.

In this instance, in operation S1106, when receiving a control signal from the display device 200 in operation 1105, the terminal device 100 outputs content data in accordance with the received control signal, generates screen sharing information about the execution screen for the output content, and transmits the generated screen sharing information to the display device 200. Here, even when the control signal is generated in the execution screen of the display device 200 of the terminal device 100, the terminal device 100 may transmit the screen sharing information about the execution screen in accordance with the control signal to the display device 200 in the same manner.

Meanwhile, when receiving content information (data) according to the control signal directly from the display device 200 and outputting the received content, the terminal device 100 may receive the content information from the display device 200, and output the received content information in the same manner as in the display device 200.

Next, a method for a screen sharing service in a display device according to an embodiment of the present invention will be described in detail with reference to the accompanying drawings.

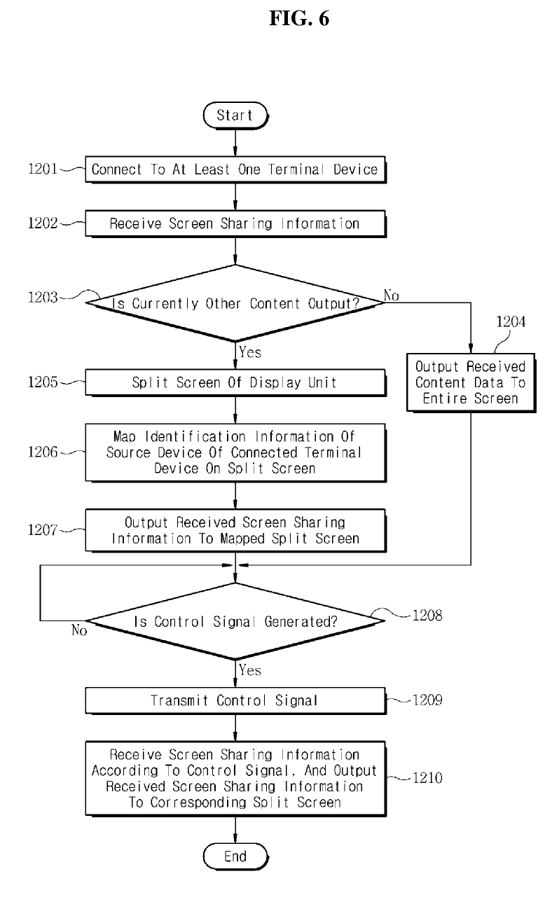

FIG. 6 is a view showing a method for a screen sharing service in a display device according to an embodiment of the present invention.

Referring to FIG. 6, in operation 1201, the display device 200 performs a connection procedure with at least one terminal device 100 via short-range wireless communication. In operation 1202, the display device 200 receives a screen sharing request message including screen sharing information about currently executed content from the connected terminal device 100 via short-range wireless communication.

Thus, in operation 1203, the display device 200 verifies whether other content information is currently output to the screen of the output unit 230. In operation 1204, when the other content information is not output based on the verification result, the display device 200 outputs the received screen sharing information to the entire screen.

On the other hand, in operation 1205, when the other content information is output, the display device 200 splits a current screen by the same number as the number of at least one terminal device 100 having transmitted the screen sharing information or the same number as the number of at least one connected terminal device 100. The display device 200 may split the screen in accordance with a condition that is determined in advance by a user in consideration of at least one of a screen size of the output unit, a screen resolution, and a type of the content as well as the number of at least one terminal device 100 having transmitted the screen sharing information and the number of at least one connected terminal device 100.

Next, in operation 1206, the display device 200 maps identification information of the terminal device 100 on the split screen, and sets a split screen region for each of the connected terminal devices 100. Thus, in operation 1207, the display device 200 outputs the received screen sharing information to the mapped corresponding split screen region.

Next, in operation 1208, the display device 200 verifies whether a control signal is generated in a current screen (split screen) of the output unit 230. In operation 1209, when the control signal is generated, the display device 200 verifies identification information mapped on the split screen in which the control signal is generated, and transmits the control signal to the terminal device 100 corresponding to the verified identification information. Next, in operation 1210, the display device 200 receives screen sharing information about the execution screen of the content executed in accordance with the control signal from the terminal device 100, and outputs the received screen sharing information to the corresponding split screen.

In this instance, the display device 200 may receive content directly from the service device in accordance with the control signal and output the received content to the corresponding split screen, and in this case, transmit content information output to the corresponding split screen to the terminal device 100.

In addition, the display device 200 may mirror the execution screen of the content executed in the current entire screen or the split screen inversely to the corresponding terminal device 100. In this case, the display device 200 may transmit screen sharing information about the current execution screen to the terminal device 100 in the same manner as in the terminal device 100, and output the transmitted screen sharing information.

Meanwhile, a recorded program instruction may be specially designed and configured for the present invention, or known and available to those of ordinary skill in the field of computer software. Examples of a computer-readable recording medium include magnetic media, such as a hard disk, a floppy disk, and a magnetic tape, optical media, such as a CD-ROM and a DVD, magneto-optical media, such as a floptical disk, and hardware devices, such as a ROM, a RAM, and a flash memory, specially configured to store and perform program commands. Examples of the program commands may include high-level language codes executable by a computer using an interpreter, etc. as well as machine language codes made by compilers. Such a hardware device may be configured to operate in one or more software modules, or vice versa in order to perform the operation of the present invention.

A computer program (also known as a program, software, soft are application, or code) mounted in the device according to the present invention and executes the method according to the present invention can be written in any form of programming languages, including compiled or interpreted languages, or declarative or procedural languages, and it can be deployed in any form. including as a stand alone program or as a module, component, subroutine, or other unit suitable for use in a computing environment. The computer program does not necessarily correspond to a file. The program can be stored in a portion of a file that holds other programs or data, in a single file dedicated to the program in question, or in multiple coordinated files (e.g., files that store one or it modules, sub-programs, or portions of code). The computer program can be deployed to be executed on one computer or on multiple computers at one site or distributed across multiple sites and interconnected by a communication network.

While the invention has been shown and described with reference to certain exemplary embodiments thereof, it will be understood by those skilled in the art that various changes in form and details may be made therein without departing from the spirit and scope of the invention as defined by the appended claims.

While this specification contains many details, these should not be construed as limitations on the scope of the invention or of what may be claimed, but rather as descriptions of features specific to particular embodiments of the invention, Certain features that are described in this specification in the context of separate embodiments can also be implemented in combination in a single embodiment, Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excluded from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

According to the apparatus and method for a screen sharing service and the screen sharing system for the same according to the embodiments of the present invention, the screen sharing information about the currently executed content is received from the plurality of terminal devices to which the display device is connected, and the received screen sharing information is output to the corresponding split screen region, and therefore the screen or the function executed in the plurality of terminal devices may be simultaneously output as is to a single display device to be executed, thereby receiving various services from the single display device.

In addition, the present invention can sufficiently come into the market or be in business and they can be obviously easily carried out, so that the present invention has industrial applicability.

In this specification, exemplary embodiments of the present invention have been classified into the first, second and third exemplary embodiments and described for conciseness. However, respective steps or functions of an exemplary embodiment may be combined with those of another exemplary embodiment to implement still another exemplary embodiment of the present invention.

What is claimed is:

1. A display device comprising:
a communication unit that performs communication for screen sharing with a plurality of terminal devices;
a screen sharing processing unit that is functionally connected to the communication unit, receives screen sharing information about content currently executed in the terminal device, splits a current screen by the same number as the number of the terminal devices having transmitted the screen sharing information, and controls the received screen sharing information to be output to a corresponding split screen; and
an output unit that outputs the received screen sharing information to the corresponding split screen in accordance with control of the screen sharing processing unit.

2. The display device of claim 1, wherein, when receiving the screen sharing information about the currently executed content from a single specific terminal device, the screen sharing processing unit controls the received screen sharing information to be output to the entire screen.

3. The display device of claim 1, wherein, when screen sharing information about another content is currently output to a screen of the output unit, the screen sharing processing unit splits the current screen, maps identification information of the terminal device having transmitted the screen sharing information to one of split screens, and controls the received screen sharing information to be output to the mapped split screen.

4. The display device of claim 1, wherein the screen sharing processing unit splits the screen in accordance with a condition that is determined in advance by a user in consideration of at least one of a screen size of the output unit, a screen resolution, and a type of the content.

5. The display device of claim 1, wherein the screen sharing processing unit merges adjacent split screen regions when there is an empty split screen from which the screen sharing information is not output among at least two split screens, and splits the merged screen region again when receiving new screen sharing information.

6. The display device of claim 1, wherein the screen sharing processing unit controls the received screen sharing information in accordance with a priority set in advance by a user in consideration of sizes of at least two split screens in the order of the sizes of the split screens.

7. The display device of claim 1, wherein the screen sharing processing unit splits a screen of the output unit by the same number as the number of the terminal devices currently connected via short-range wireless communication, and outputs content information directly executed in the display device to an empty split screen from which the screen sharing information is not output among at least two split screens.

8. The display device of claim 1, wherein, when content which is received directly from the display device to be executed occurs, the screen sharing processing unit sets the number of split screens by adding the content, and splits a screen currently executed by the set number of split screens.

9. The display device of claim 1, wherein, when a control signal is generated, the screen sharing processing unit receives content information in accordance with the control signal directly from a service device for providing the content, outputs the received content information to a corresponding split screen in which the control signal is generated, transmits the received content information to the terminal device mapped on the corresponding split screen, and controls the content information to be output in the same manner as in the corresponding split screen.

10. The display device of claim 1, wherein, when a control signal is generated, the screen sharing processing unit verifies identification information mapped on a split screen in which the control signal is generated, transmits the control signal to the terminal device corresponding to the verified identification information, receives screen sharing information about the output content in accordance with the control signal from the terminal device corresponding to the identification information, and controls the received screen sharing information to be output to the split screen in which the control signal is generated.

11. The display device of claim 1, wherein the screen sharing information includes at least one of a mirrored screen in the terminal device, a content voice, and content data.

12. A terminal device comprising:
a communication unit that performs communication for screen sharing via a communication network with a display device connected via the communication network;
a control unit that generates screen sharing information about content executed on a current execution screen in accordance with a screen sharing request of a user, and controls a screen sharing request message including the generated screen sharing information to be transmitted to the display device so that the same screen as the current execution screen is output to a split screen region of the display device allocated to the terminal device itself; and
an output unit that outputs an execution screen about the content.

13. The terminal device of claim 12, wherein the control unit is connected to the display device acting as an access point via short-range wireless communication.

14. The terminal device of claim 12, wherein, when receiving a control signal from the display device, the control unit outputs content information provided in accordance with the received control signal to the execution screen, generates screen sharing information about content currently output to the execution screen, and transmits the generated screen sharing information to the display device so that the generated screen sharing information is equally output to a corresponding split screen of the display device.

15. The terminal device of claim 12, wherein, when a control signal in accordance with a request of the user is generated, the control unit outputs content information in accordance with the generated control signal to the current execution screen, generates screen sharing information about content currently output to the execution screen, and transmits the generated screen sharing information to the display device so that the generated screen sharing information is equally output to a corresponding split screen of the display device.

16. A screen sharing service method in a display device comprising:
receiving a screen sharing request message including screen sharing information about content currently executed in at least two terminal devices;
splitting a current screen by the same number as the number of at least one terminal device having transmitted the screen sharing information; and
outputting the received screen sharing information to a split screen corresponding to the terminal device having requested screen sharing.

17. The screen sharing service method of claim 16, further comprising:
performing a connection procedure with the at least two terminal devices in accordance with a connection request of the at least two terminal devices through an access point function of short-range wireless communication.
